(19) United States
(12) Patent Application Publication
(10) Pub. No.: US 2011/0286513 A1
(43) Pub. Date: Nov. 24, 2011

(54) METHODS AND APPARATUS FOR ADAPTIVE MODE VIDEO ENCODING AND DECODING

(76) Inventors: Yunfei Zheng, Plainsboro, NJ (US); Xiaoan Lu, Princeton, NJ (US); Jole Sole, Princeton, NJ (US); Peng Yin, Ithaca, NY (US); Qian Xu, Plainsboro, NJ (US)

(21) Appl. No.: 13/138,239

(22) PCT Filed: Dec. 11, 2009
(86) PCT No.: PCT/US2009/006505

§ 371 Date: Jul. 22, 2011

Related U.S. Application Data
(60) Provisional application No. 61/150,115, filed on Feb. 5, 2009.

(51) Int. Cl. H04N 11/02

(52) U.S. Cl. 375/240.02; 375/E07.026

(57) ABSTRACT

There are provided methods and apparatus for adaptive mode video encoding and decoding. An apparatus includes an encoder for encoding adapted mode mapping information for a mapping between values of a mode index and modes available to encode at least a portion of a picture in a sequence of pictures. The adapted mode mapping information is adapted based on one or more actual parameters of the sequence.

### CROSS-REFERENCE TO RELATED APPLICATIONS

This application claims the benefit of U.S. Provisional Application Ser. No. 61/150,115, filed Feb. 5, 2009, which is incorporated by reference herein in its entirety.

### TECHNICAL FIELD

The present principles relate generally to video encoding and decoding and, more particularly, to methods and apparatus for adaptive mode video encoding and decoding.

### BACKGROUND

Most modern video coding standards employ various coding modes to efficiently reduce the correlation in the spatial and temporal domains. As an example for illustrative purposes, the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”) allows a picture to be intra or inter coded. In intra pictures, all macroblocks are coded in intra modes. In the MPEG-4 AVC Standard, Intra modes can be classified into three types: INTRA4×4; INTRA8×8; and INTRA16×16. INTRA4×4 and INTRA8×8 support 9 intra prediction modes and INTRA16×16 supports 4 intra prediction modes. In inter frames, an encoder makes an inter/intra coding decision for each macroblock. Inter coding allows various block partitions (more specifically 16×16, 16×8, 8×16, and 8×8 for a macroblock, and 8×8, 8×4, 4×8, 4×4 for an 8×8 sub-macroblock partition). Each partition has several prediction modes since a multiple reference pictures strategy is used for predicting a 16×16 macroblock. Furthermore, the MPEG-4 AVC Standard also supports skip and direct modes.

Furthermore, the MPEG-4 AVC Standard employs a pre-defined fixed compression method to code the block type (partition) and prediction modes, and lacks the adaptation in matching these to the actual video content.

As previously stated, in the MPEG-4 AVC Standard, a picture can be intra or inter coded. In intra coded pictures, all macroblocks are coded in intra modes by only exploiting spatial information of current picture. In inter coded pictures (P and B pictures) both inter and intra modes are used. Each individual macroblock is either coded as intra (i.e., using only spatial correlation) or coded as inter (i.e. using temporal correlation from previously coded pictures). Generally, an encoder makes an inter/intra coding decision for each macroblock based on coding efficiency and subjective quality considerations. Inter coding is typically used for macroblocks that are well predicted from previous pictures, and intra coding is generally used for macroblocks that are not well predicted from previous pictures, or for macroblocks with low spatial activities.

Intra modes allow three types: INTRA4×4; INTRA8×8; and INTRA16×16. INTRA4×4 and INTRA8×8 support 9 modes: vertical; horizontal; DC; diagonal-down/left; diagonal-down/right; vertical-left; horizontal-down; vertical-right; and horizontal-up prediction. INTRA16×16 supports 4 modes: vertical; horizontal; DC; and plane prediction. Turning to FIG. 1A, INTRA4×4 and INTRA8×8 prediction modes are indicated generally by the reference numeral 100. In FIG. 1A, the reference numeral 0 indicates a vertical prediction mode, the reference numeral 1 indicates a horizontal prediction mode, the reference numeral 3 indicates a diagonal-down/left prediction mode, the reference numeral 4 indicates a diagonal-down/right prediction mode, the reference numeral 5 indicates a vertical-right prediction mode, the reference numeral 6 indicates a horizontal-down prediction mode, the reference numeral 7 indicates a vertical-left prediction mode, and the reference numeral 8 indicates a horizontal-up prediction mode. DC mode, which is part of the INTRA4×4 and INTRA8×8 prediction modes, is not shown. Turning to FIG. 1B, INTRA16×16 prediction modes are indicated generally by the reference numeral 150. In FIG. 1B, the reference numeral 0 indicates a vertical prediction mode, the reference numeral 1 indicates a horizontal prediction mode, and the reference numeral 3 indicates a plane prediction mode. DC mode, which is part of the INTRA16×16 prediction modes, is not shown.

In inter pictures, an encoder makes an inter/intra coding decision for each macroblock. In the MPEG-4 AVC Standard, inter coding allows various block partitions (more specifically 16×16, 16×8, 8×16, and 8×8 for a macroblock, and 8×8, 8×4, 4×8, 4×4 for an 8×8 sub-macroblock partition) and multiple reference pictures to be used for predicting a 16×16 macroblock. Furthermore, the MPEG-4 AVC Standard also supports skip and direct modes.

In the reference software for the MPEG-4 AVC Standard, a Rate-Distortion Optimization (RDO) framework is used, where mode decision is made by comparing the cost of each inter mode and intra mode. The mode with the minimal cost is selected as the best mode.

Mode Coding in the MPEG-4 AVC Standard

To exploit the non-stationary characteristics of input video content, a video encoder relies on entropy coding to map the input video signal to a bitstream of variable length-coded syntax elements. Frequently-occurring symbols are represented with short code words while less common symbols are represented with long code words.

The MPEG-4 AVC Standard supports two entropy coding methods. The symbols are coded using either variable-length codes (VLCs) or context-adaptive arithmetic coding (CABAC) depending on the entropy encoding mode. Using CABAC as an example entropy coding method and sub_mb_type in P slices as an example symbol, we illustrate how the mode is coded in the MPEG-4 AVC Standard.

The CABAC encoding process includes the following three elementary steps:

(1) binarization;

(2) context modeling; and

(3) binary arithmetic coding.

In the binarization step, a given non-binary valued syntax element is uniquely mapped to a binary sequence, called a bin string. This process is similar to the process of converting a symbol into a variable length code but the binary code is further encoded. Turning to FIG. 2A, a mapping between code mode and mode index for the syntax element sub_mb_type in P slices are indicated generally by the reference numeral 200. The mode is indexed from 0 to 3, i.e., P_L0_{—}8×8 has an index value of 0, P_L0_{—}8×4 1, P_L0_{—}4×8 2, and P_L0_{—}4×4 3. sub_mb_type 0 is expected to occur more often and is converted into a 1-bit bin string while sub_mb_type 2 and 3 are expected less and are converted to 3-bit bin strings. The binarization process is fixed and cannot adapt to the mode selection that differs from the expected behavior.

Similarly, the encoding processes for other modes, including but not limited to mb_type and intra prediction modes, are also fixed in the MPEG-4 AVC Standard. Therefore, the MPEG-4 AVC Standard fails to capture the dynamic nature of the video signal and there is a strong need to design an adaptive method to encode the modes and improve the coding efficiency. Thus, the MPEG-4 AVC Standard, as with most modern video coding standards and recommendations, employs various coding modes to efficiently reduce the correlation in the spatial and temporal domains. However, these video standards and recommendations employ a pre-defined fixed compression method to code the block type (partition) and prediction modes, and lack the adaptation in matching these to the actual video content.

### SUMMARY

These and other drawbacks and disadvantages of the prior art are addressed by the present principles, which are directed to methods and apparatus for adaptive mode video encoding and decoding.

According to an aspect of the present principles, there is provided an apparatus. The apparatus includes an encoder for encoding adapted mode mapping information for a mapping between values of a mode index and modes available to encode at least a portion of a picture in a sequence of pictures. The adapted mode mapping information is adapted based on one or more actual parameters of the sequence.

According to another aspect of the present principles, there is provided a method. The method includes encoding adapted mode mapping information for a mapping between values of a mode index and modes available to encode at least a portion of a picture in a sequence of pictures. The adapted mode mapping information is adapted based on one or more actual parameters of the sequence.

According to yet another aspect of the present principles, there is provided an apparatus. The apparatus includes a decoder for decoding adapted mode mapping information for a mapping between values of a mode index and modes available to decode at least a portion of a picture in a sequence of pictures. The adapted mode mapping information is adapted based on one or more actual parameters of the sequence.

According to still another aspect of the present principles, there is provided a method. The method includes decoding adapted mode mapping information for a mapping between values of a mode index and modes available to decode at least a portion of a picture in a sequence of pictures. The adapted mode mapping information is adapted based on one or more actual parameters of the sequence.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1A is a diagram showing INTRA4×4 and INTRA8×8 prediction modes to which the present principles may be applied;

FIG. 1B is a diagram showing INTRA16×16 prediction modes to which the present principles may be applied;

FIG. 2A is a diagram showing a mapping between coding mode and mode index for the syntax element sub_mb_type in P slices;

FIG. 2B is a diagram showing an alternate mapping between coding mode and mode index for the syntax element sub_mb_type in P slices, in accordance with an embodiment of the present principles;

FIG. 3 is a block diagram showing an exemplary video encoder to which the present principles may be applied, in accordance with an embodiment of the present principles;

FIG. 4 is a block diagram showing an exemplary video decoder to which the present principles may be applied, in accordance with an embodiment of the present principles;

FIG. 5 is a flow diagram showing an exemplary method for deriving adaptive mode coding in a video encoder, in accordance with an embodiment of the present principles;

FIG. 6 is a flow diagram showing an exemplary method for deriving adaptive mode coding in a video decoder, in accordance with an embodiment of the present principles;

FIG. 7 is a flow diagram showing an exemplary method for applying adaptive mode coding on a sequence level in a video encoder, in accordance with an embodiment of the present principles;

FIG. 8 is a flow diagram showing an exemplary method for applying adaptive mode coding on a sequence level in a video decoder, in accordance with an embodiment of the present principles;

FIG. 9 is a flow diagram showing an exemplary method for adaptive mode mapping in a video encoder, in accordance with an embodiment of the present principles; and

FIG. 10 is a flow diagram showing an exemplary method for adaptive mode mapping in a video decoder, in accordance with an embodiment of the present principles.

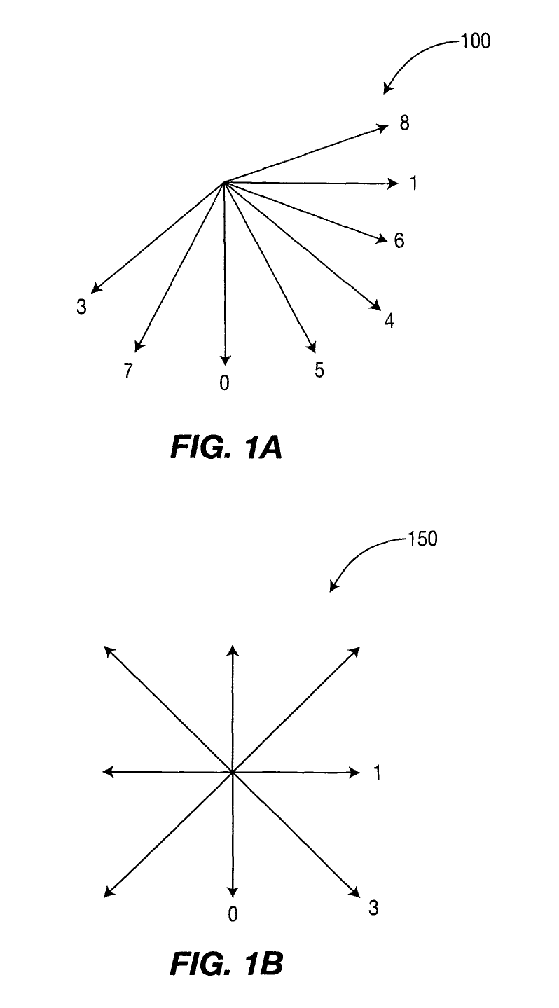

### DETAILED DESCRIPTION

The present principles are directed to methods and apparatus for adaptive mode video encoding and decoding.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, it is to be appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

Further, as used herein, “high level syntax” refers to syntax present in the bitstream that resides hierarchically above the macroblock layer. For example, high level syntax, as used herein, may refer to, but is not limited to, syntax at the slice header level, Supplemental Enhancement Information (SEI) level, Picture Parameter Set (PPS) level, Sequence Parameter Set (SPS) level and Network Abstraction Layer (NAL) unit header level.

As noted above, the present principles are directed to methods and apparatus for adaptive mode video encoding and decoding.

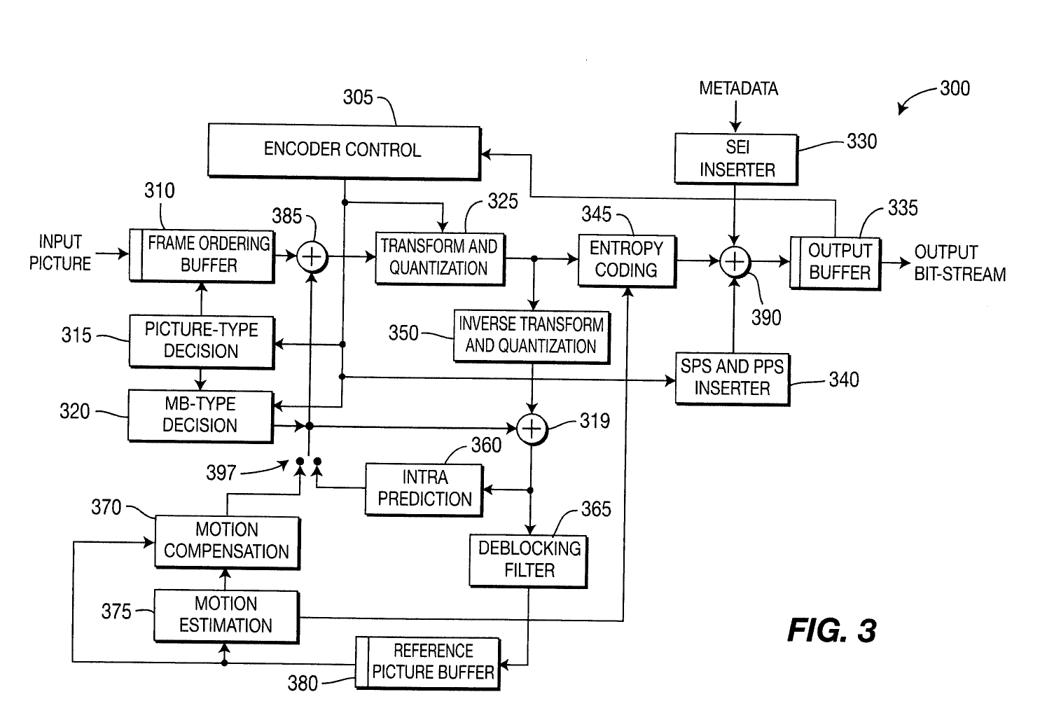

Turning to FIG. 3, an exemplary video encoder to which the present principles may be applied is indicated generally by the reference numeral 300.

The video encoder 300 includes a frame ordering buffer 310 having an output in signal communication with a non-inverting input of a combiner 385. An output of the combiner 385 is connected in signal communication with a first input of a transformer and quantizer 325. An output of the transformer and quantizer 325 is connected in signal communication with a first input of an entropy coder 345 and a first input of an inverse transformer and inverse quantizer 350. An output of the entropy coder 345 is connected in signal communication with a first non-inverting input of a combiner 390. An output of the combiner 390 is connected in signal communication with a first input of an output buffer 335.

An output of an encoder controller 305 is connected in signal communication with an input of a picture-type decision module 315, a first input of a macroblock-type (MB-type) decision module 320, a second input of the transformer and quantizer 325, and an input of the Sequence Parameter Set (SPS) and Picture Parameter Set (PPS) inserter 340.

An output of the SEI inserter 330 is connected in signal communication with a second non-inverting input of the combiner 390.

A first output of the picture-type decision module 315 is connected in signal communication with a third input of the frame ordering buffer 310. A second output of the picture-type decision module 315 is connected in signal communication with a second input of a macroblock-type decision module 320.

An output of the Sequence Parameter Set (SPS) and Picture Parameter Set (PPS) inserter 340 is connected in signal communication with a third non-inverting input of the combiner 390.

An output of the inverse quantizer and inverse transformer 350 is connected in signal communication with a first non-inverting input of a combiner 319. An output of the combiner 319 is connected in signal communication with a first input of the intra prediction module 360 and a first input of the deblocking filter 365. An output of the deblocking filter 365 is connected in signal communication with an input of a reference picture buffer 380. An output of the reference picture buffer 380 is connected in signal communication with a second input of the motion estimator 375 and a first input of the motion compensator 370. A first output of the motion estimator 375 is connected in signal communication with a second input of the motion compensator 370. A second output of the motion estimator 375 is connected in signal communication with a second input of the entropy coder 345.

An output of the motion compensator 370 is connected in signal communication with a first input of a switch 397. An output of the intra prediction module 360 is connected in signal communication with a second input of the switch 397. An output of the macroblock-type decision module 320 is connected in signal communication with a third input of the switch 397. The third input of the switch 397 determines whether or not the “data” input of the switch (as compared to the control input, i.e., the third input) is to be provided by the motion compensator 370 or the intra prediction module 360. The output of the switch 397 is connected in signal communication with a second non-inverting input of the combiner 319 and a second non-inverting input of the combiner 385. A second output of the output buffer 335 is connected in signal communication with an input of the encoder controller 305.

A first input of the frame ordering buffer 310 is available as an input of the encoder 100, for receiving an input picture. Moreover, an input of the Supplemental Enhancement Information (SEI) inserter 330 is available as an input of the encoder 300, for receiving metadata. A third output of the output buffer 335 is available as an output of the encoder 300, for outputting a bitstream.

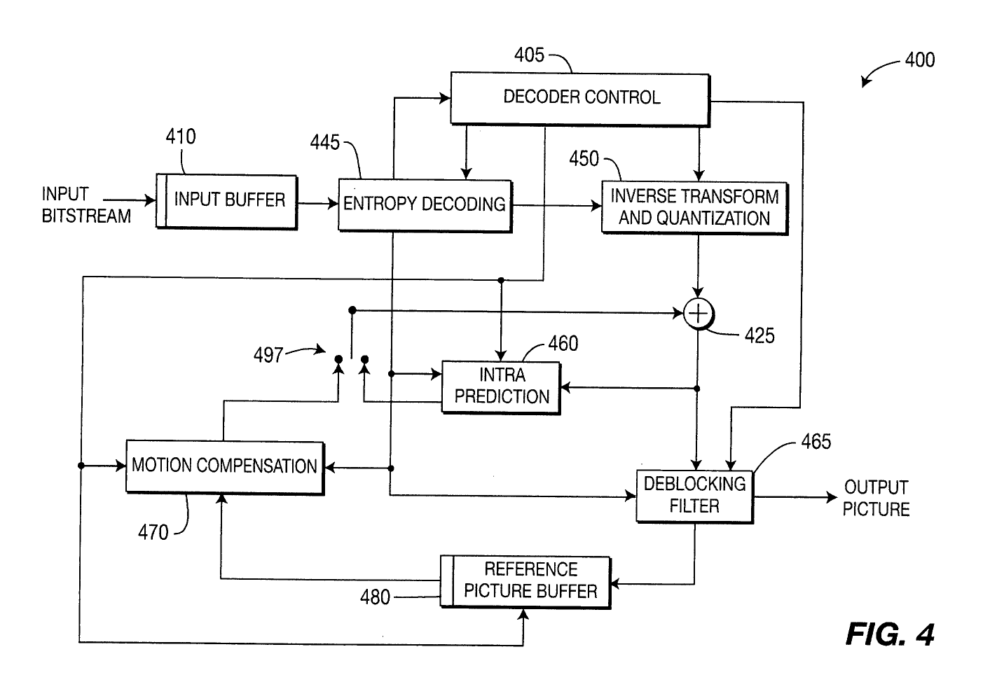

Turning to FIG. 4, an exemplary video decoder to which the present principles may be applied is indicated generally by the reference numeral 400.

The video decoder 400 includes an input buffer 410 having an output connected in signal communication with a first input of the entropy decoder 445. A first output of the entropy decoder 445 is connected in signal communication with a first input of an inverse transformer and inverse quantizer 450. An output of the inverse transformer and inverse quantizer 450 is connected in signal communication with a second non-inverting input of a combiner 425. An output of the combiner 425 is connected in signal communication with a second input of a deblocking filter 465 and a first input of an intra prediction module 460. A second output of the deblocking filter 465 is connected in signal communication with a first input of a reference picture buffer 480. An output of the reference picture buffer 480 is connected in signal communication with a second input of a motion compensator 470.

A second output of the entropy decoder 445 is connected in signal communication with a third input of the motion compensator 470 and a first input of the deblocking filter 465. A third output of the entropy decoder 445 is connected in signal communication with an input of a decoder controller 405. A first output of the decoder controller 405 is connected in signal communication with a second input of the entropy decoder 445. A second output of the decoder controller 405 is connected in signal communication with a second input of the inverse transformer and inverse quantizer 450. A third output of the decoder controller 405 is connected in signal communication with a third input of the deblocking filter 465. A fourth output of the decoder controller 405 is connected in signal communication with a second input of the intra prediction module 460, a first input of the motion compensator 470, and a second input of the reference picture buffer 480.

An output of the motion compensator 470 is connected in signal communication with a first input of a switch 497. An output of the intra prediction module 460 is connected in signal communication with a second input of the switch 497. An output of the switch 497 is connected in signal communication with a first non-inverting input of the combiner 425.

An input of the input buffer 410 is available as an input of the decoder 400, for receiving an input bitstream. A first output of the deblocking filter 465 is available as an output of the decoder 400, for outputting an output picture.

Thus, in accordance with the present principles, we provide methods and apparatus for adaptive mode video encoding and decoding. The use of adaptive modes allows for improved coding efficiency. In an embodiment, we adapt the mapping between the mode and the mode index to reduce the required number of bits in coding modes. In an embodiment, coding efficiency is increased by setting more frequently occurring modes to index values that lead to shorter code lengths.

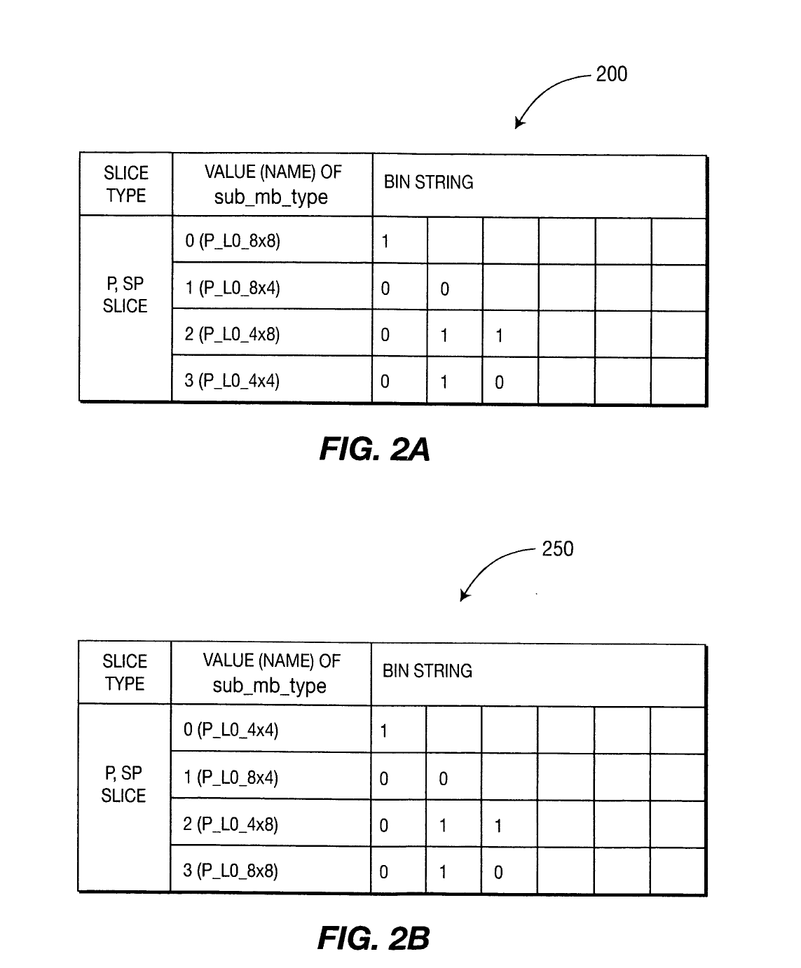

Turning to FIG. 2B, an alternate mapping between the coding mode and the mode index for the example symbol sub_mb_type in FIG. 2A is indicated generally by the reference numeral 250. In the alternative mapping 250, the smallest block size (i.e., 4×4) has the smallest index (i.e., 0) and therefore the shortest codeword (i.e., 1). One particular adaptive mode coding method is to choose between these two mapping tables in FIG. 2A and FIG. 2B, depending on the mode statistics. When the P_L0_{—}8×8 mode is dominant, then the table in FIG. 2A is chosen. When the P_L0_{—}4×4 mode is dominant, then the table in FIG. 2B is chosen.

### Embodiment 1

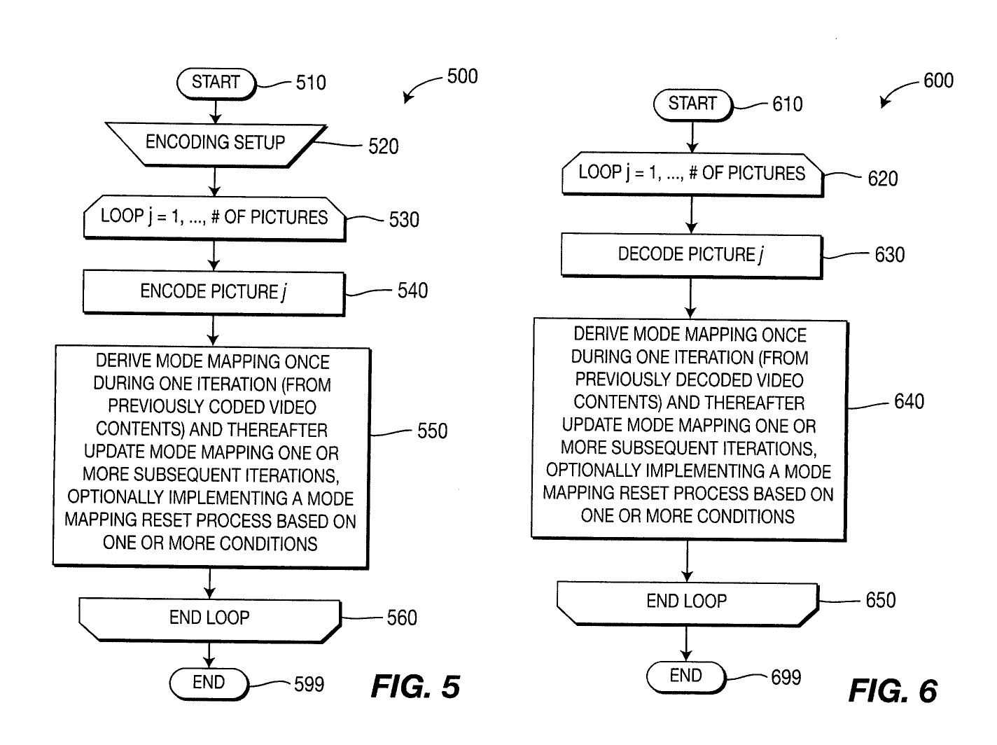

Turning to FIG. 5, an exemplary method for deriving adaptive mode coding in a video encoder is indicated generally by the reference numeral 500. The method 500 includes a start block 510 that passes control to a function block 520. The function block 520 performs an encoding setup (optionally with operator assistance), and passes control to a loop limit block 530. The loop limit block 530 performs a loop j, where j=1, . . . # of pictures (with the symbol “#” representing the word “number”), and passes control to a function block 540. The function block 540 encodes picture j, and passes control to a function block 550. The function block 550 derives a mode mapping from previously coded video contents during one iteration (not necessarily the first iteration), and thereafter updates the mode mapping one or more times during one or more subsequent iterations, optionally implementing a mode mapping reset process based on one or more conditions (e.g., a scene change, etc.), and passes control to a loop limit block 560. The loop limit block 560 ends the loop, and passes control to an end block 599.

In method 500, the mapping between the mode and the mode index is derived from previously coded video contents. The decision rules can be based on, for example, but is not limited to, the frequency of the mode usage in previously coded pictures, together with other information such as the temporal and spatial resolutions. Of course, other parameters may also be used, together with the previously specified parameters and/or in place of one or more of the previously specified parameters. In method 500, the adaptive mode mapping is updated after each picture is coded. However, it is to be appreciated that the present principles are not limited to the preceding update frequency and, thus, other updates frequencies may also be used while maintaining the spirit of the present principles. For example, the update process can also be applied after a few pictures such as, for example, a group of pictures (GOP) or a scene, to reduce the computational complexity. To update the mode mapping, one or more coded pictures can be used. The volume of previously coded pictures to be used can be based on some rules that are known to both the encoder and decoder. In an embodiment, a particular mode mapping reset process can also be incorporated to reset the mapping table to the default one at the scene change.

Turning to FIG. 6, an exemplary method for deriving adaptive mode coding in a video decoder is indicated generally by the reference numeral 600. The method 600 includes a start block 610 that passes control to a loop limit block 620. The loop limit block 620 begins a loop j, where j=1, . . . # of pictures (with the symbol “#” representing the word “number”), and passes control to a function block 630. The function block 630 decodes picture j, and passes control to a function block 640. The function block 640 derives a mode mapping from previously decoded video contents during one iteration (not necessarily the first iteration), and thereafter updates the mode mapping one or more times during one or more subsequent iterations, optionally implementing a mode mapping reset process based on one or more conditions (e.g., a scene change, etc.), and passes control to a loop limit block 650. The loop limit block 650 ends the loop, and passes control to an end block 699.

Thus, after each picture is decoded in block 630, the mode mapping is updated in the same fashion as in the encoder.

In this method, the adaptive mode mapping is derived from previously coded pictures. One of many advantages of this method is that the method adapts to the content and does not require extra syntax in conveying the mapping information. However, the method may involve extra computation at the encoder and decoder to derive the mapping. In addition, when the bitstream is transmitted in an error-prone environment, the mapping may not be derived properly if previously coded pictures are damaged which may prevent the decoder from functioning properly.

### Embodiment 2

In another embodiment, the mapping information is specifically indicated in the syntax and conveyed in the bitstream. In this method, the adaptive mode mapping can be derived before or during the encoding process. For example, according to the training data from encodings at different spatial resolutions, a mode mapping table can be generated for a range of spatial resolutions. The mapping is then coded on a sequence level, a picture level, a slice level, and/or so forth.

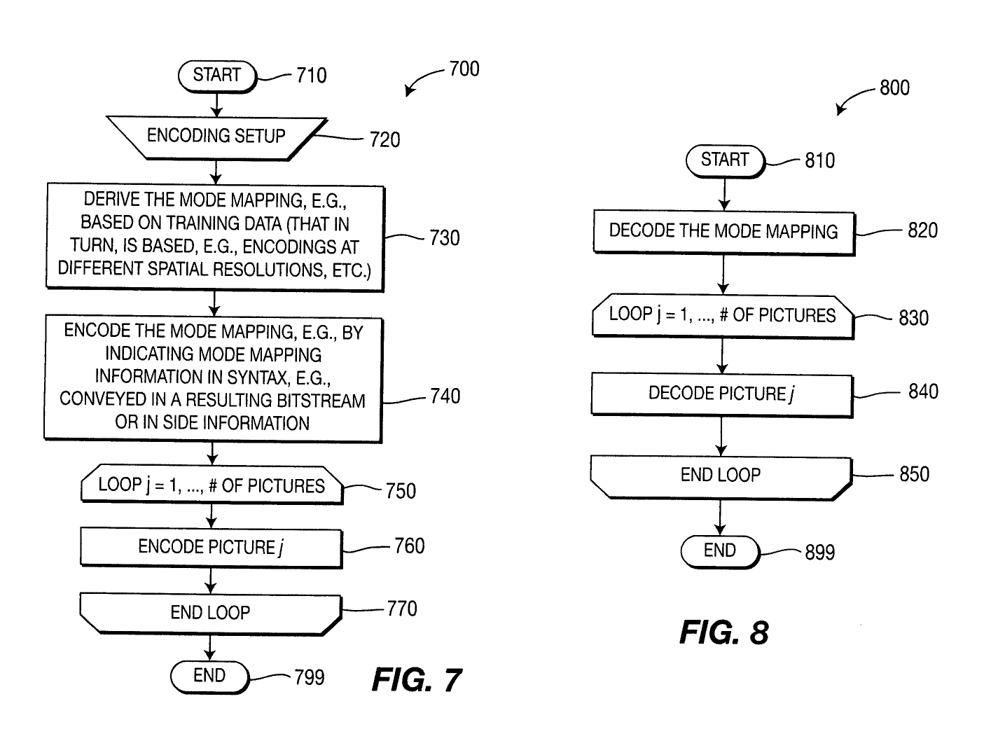

Turning to FIG. 7, an exemplary method for applying adaptive mode coding on a sequence level in a video encoder is indicated generally by the reference numeral 700. The method 700 embeds the mode mapping in the resultant bitstream. The method 700 includes a start block 710 that passes control to a function block 720. The function block 720 performs an encoding setup (optionally with operator assistance), and passes control to a function block 730. The function block 730 derives the mode mapping, e.g., based on training data (that, in turn, is based on, e.g., encodings at different spatial resolutions, etc.), and passes control to a function block 740. The function block 740 encodes the mode mapping, for example, by indicating the mode mapping information in syntax conveyed in a resultant bitstream or in side information, and passes control to a loop limit block 750. The loop limit block 750 performs a loop j, where j=1, . . . # of pictures (with the symbol “#” representing the word “number”), and passes control to a function block 760. The function block 760 encodes picture j, and passes control to a function block 770. The loop limit block 770 ends the loop, and passes control to an end block 799.

Turning to FIG. 8, an exemplary method for applying adaptive mode coding on a sequence level in a video decoder is indicated generally by the reference numeral 800. The method 800 parses a received bitstream that includes the mode mapping embedded therein. The method 800 includes a start block 810 that passes control to a function block 820. The function block 820 decodes the mode mapping, and passes control to a loop limit block 830. The loop limit block 830 performs a loop j, where j=1, . . . # of pictures (with the symbol “#” representing the word “number”), and passes control to a function block 840. The function block 840 decodes picture j, and passes control to a loop limit block 850. The loop limit block 850 ends the loop, and passes control to an end block 899.

In the preceding methods 700 and 800, the mode mapping information is specifically sent in the bitstream. This enables the decoder to obtain such information without referring to previously coded pictures and therefore provides a bitstream that is more robust to transmission errors. However, there may be a cost of more overhead bits in sending the mode mapping information.

### Embodiment 3

In another embodiment, the mapping information is also indicated in the syntax and conveyed in the bitstream. Different from embodiment 2, the mapping table can be generated during the encoding/decoding process based on the previously encoded pictures or currently encoded picture. For example, before encoding a picture, a mode mapping table is generated and indicated in the syntax. We can keep updating the mode mapping table during the encoding process. The mode mapping table can be generated based on the previously coded picture information and/or selected from some mode mapping table set and/or different/partial encoding passes of the currently encoded picture. The mapping table can also be generated based on the statistics of the encoded picture or sequence such as, for example, but not limited to, mean, variance, and so forth.

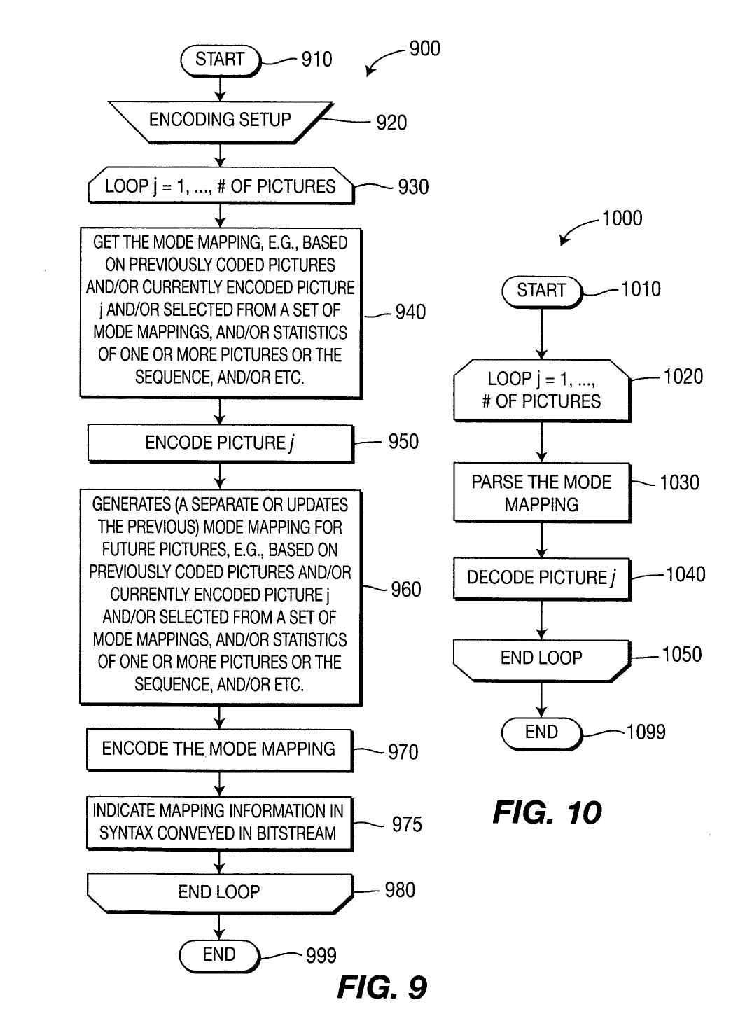

Turning to FIG. 9, an exemplary method for adaptive mode mapping in a video encoder is indicated generally by the reference numeral 900. The method 900 includes a start block 910 that passes control to a function block 920. The function block 920 performs an encoding setup, and passes control to a loop limit block 930. The loop limit block 930 performs a loop j, where j=1, . . . , # of pictures (with the symbol “#” representing the word “number”), and passes control to a function block 940. The function block 940 gets the mode mapping, e.g., based on previously coded pictures and/or currently encoded picture j and/or selected from a set of mode mappings, and/or statistics of one or more pictures or the sequence, and/or etc., and passes control to a function block 950. The function block 950 encodes picture j, and passes control to a function block 960. The function block 960 generates (a separate or updates the previous) mode mapping for one or more future pictures (to be encoded), e.g., based on previously coded pictures and/or currently encoded picture j and/or selected from a set of mode mappings, and/or statistics of one or more pictures or the sequence, and/or etc., and passes control to a function block 970. The function block 970 encodes the mode mapping, and passes control to a function block 975. The function block 975 indicates mapping information in syntax conveyed in a resulting bitstream, and passes control to a loop limit block 980. The loop limit block 980 ends the loop, and passes control to an end block 999.

In one embodiment of method 900, block 940 gets the mode mapping from the previously encoded pictures. The previously encoded pictures used for deriving the mode mapping can be the same pictures encoded in the previous encoding passes, or other pictures encoded before them.

Turning to FIG. 10, an exemplary method for adaptive mode mapping in a video decoder is indicated generally by the reference numeral 1000. The method 1000 includes a start block 1010 that passes control to a loop limit block 1020. The loop limit block 1020 performs a loop j, where j=1, . . . # of pictures (with the symbol “#” representing the word “number”), and passes control to a function block 1030. The function block 1030 parses the mode mapping, and passes control to a function block 1040. The function block 1040 decodes picture j, and passes control to a loop limit block 1050. The loop limit block 1050 ends the loop, and passes control to an end block 1099.

In this approach, the mode mapping is adaptively updated during the encoding process, which is helpful to capture the non-stationaries of video sequences. The mode mapping table is explicitly sent in the bitstream to make the encoding and decoding processes more robust.

### Syntax

The adaptive mapping between the mode and mode index can be specified in the high level syntax. In one embodiment, we show an example of how to define the syntax for the INTRA frames for use in accordance with the present principles. The fixed mapping in the MPEG-4 AVC Standard is used as the default mapping at both the encoder and decoder sides. Our proposed method provides the flexibility to use other mappings through the sequence parameter set or picture parameter set. Syntax examples in the sequence parameter set and picture parameter set are shown in TABLE 1 and TABLE 2, respectively. Similar syntax changes can be applied to inter frames and other syntax elements, on various levels, while maintaining the spirit of the present principles.

TABLE 1

| | | |
|---|---|---|
| seq_parameter_set_rbsp( ){ | C | Descriptor |

...

| | | |
|---|---|---|
| seq_mb_type_adaptation_present_flag | 0 | u(1) |
| if(seq_mb_type_adaptation_present_flag){ | | |

for (i=0; i<3; i++) {

| | | |
|---|---|---|
| mb_type_adaptive_index[ i ] | 0 | u(2) |

}

| | | |
|---|---|---|
| } | | |
| seq_intra4x4_prediction_mode_adaptation_present_flag | 0 | u(1) |
| if(seq_intra4x4_prediction_mode_adaptation_present_flag){ | | |

for (i=0; i<9; i++) {

| | | |
|---|---|---|
| Intra4x4_prediction_mode_adaptive_index[ i ] | 0 | u(4) |

}

| | | |
|---|---|---|
| } | | |
| seq_intra16x16_prediction_mode_adaptation_present_flag | 0 | u(1) |
| if(seq_intra16x16_prediction_mode_adaptation_present_flag){ | | |

for (i=0; i<4; i++) {

| | | |
|---|---|---|
| Intra16x16_prediction_mode_adaptive_index[ i ] | 0 | u(2) |

}

}
...

}

TABLE 2

| | | |
|---|---|---|
| pic_parameter_set_rbsp( ){ | C | Descriptor |

...

| | | |
|---|---|---|
| pic_mb_type_adaptation_present_flag | 0 | u(1) |
| if(pic_mb_type_adaptation_present_flag){ | | |

for (i=0; i<3; i++) {

| | | |
|---|---|---|
| mb_type_adaptive_index[ i ] | 0 | u(2) |

}

| | | |
|---|---|---|
| } | | |
| pic_intra4x4_prediction_mode_adaptation_present_flag | 0 | u(1) |
| if(pic_intra4x4_prediction_mode_adaptation_present_flag){ | | |

for (i=0; i<9; i++) {

| | | |
|---|---|---|
| Intra4x4_prediction_mode_adaptive_index[ i ] | 0 | u(4) |

}

| | | |
|---|---|---|
| } | | |
| pic_intra16x16_prediction_mode_adaptation_present_flag | 0 | u(1) |
| if(pic_intra16x16_prediction_mode_adaptation_present_flag){ | | |

for (i=0; i<4; i++) {

| | | |
|---|---|---|
| Intra16x16_prediction_mode_adaptive_index[ i ] | 0 | u(2) |

}

}
...

}

The syntax in the sequence parameter set is as follows:

seq_mb_type_adaptation_present_flag equal to 1 specifies that adaptive mode mapping is present in the sequence parameter set.

seq_mb_type_adaptation_present_flag equal to 0 specifies that adaptive mode mapping is not present in the sequence parameter set. The default mapping is used.

mb_type_adaptive_index[i] specifies the value of the new mode index where i is the index for the default mapping.

seq_intra4×4_prediction_mode_adaptation_present_flag equal to 1 specifies that adaptive INTRA4×4 and INTRA8×8 prediction mode mapping is present in the sequence parameter set. seq_intra4×4_prediction_mode_adaptation_present_flag equal to 0 specifies that adaptive INTRA4×4 and INTRA8×8 prediction mode mapping is not present in the sequence parameter set. The default mapping is used.

Intra4×4_prediction_mode_adaptive_index[i] specifies the value of the new INTRA4×4 and INTRA8×8 mode index where i is the index for the default mapping.

seq_intra16×16_prediction_mode_adaptation_present_flag equal to 1 specifies that adaptive INTRA16×16 prediction mode mapping is present in the sequence parameter set. seq_intra16×16_prediction_mode_adaptation_present_flag equal to 0 specifies that adaptive INTRA16×16 prediction mode mapping is not present in the sequence parameter set. The default mapping is used.

Intra16×16_prediction_mode_adaptive_index[i] specifies the value of the new INTRA16×16 mode index where i is the index for the default mapping.

The syntax in the picture parameter set is as follows:

pic_mb_type_adaptation_present_flag equal to 1 specifies that adaptive mode mapping is present in the picture parameter set.

pic_mb_type_adaptation_present_flag equal to 0 specifies that adaptive mode mapping is not present in the picture parameter set. The default mapping is used.

mb_type_adaptive_index[i] specifies the value of new mode index where i is the index for the default mapping.

pic_intra4×4_prediction_mode_adaptation_present_flag equal to 1 specifies that adaptive INTRA4×4 and INTRA8×8 prediction mode mapping is present in the picture parameter set. pic_intra4×4_prediction_mode_adaptation_present_flag equal to 0 specifies that adaptive INTRA4×4 and INTRA8×8 prediction mode mapping is not present in the picture parameter set. The default mapping is used.

Intra4×4_prediction_mode_adaptive_index[i] specifies the value of the new INTRA4×4 and INTRA8×8 mode index where i is the index for the default mapping.

pic_intra16×16_prediction_mode_adaptation_present_flag equal to 1 specifies that adaptive INTRA16×16 prediction mode mapping is present in the picture parameter set. pic_intra16×16_prediction_mode_adaptation_present_flag equal to 0 specifies that adaptive INTRA16×16 prediction mode mapping is not present in the picture parameter set. The default mapping is used.

Intra16×16_prediction_mode_adaptive_index[i] specifies the value of the new INTRA16×16 mode index where i is the index for the default mapping.

### Variation

In this variation, we provide another specific example on how to adapt the INTRA mode mapping. Presume there are two INTRA modes: INTRA4×4; and INTRA8×8. Also presume that the preceding two INTRA modes are coded with the Exp-Golomb codewords. For this specific example, we call the INTRA mode SIP type (sip_type).

### Syntax

The syntax change for this specific example is provided in TABLE 3. The mapping for the low resolution video is used as the default mapping at both the encoder and decoder. In some applications, we can also use the mapping for other resolutions as the default mapping. Our proposed method provides the flexibility to use other mappings through the sequence parameter set or picture parameter set. TABLE 3 shows the syntax changes in the picture parameter set. Similar syntax changes can be applied on other syntax levels, including but not limited to the sequence parameter set.

TABLE 3

| | | |
|---|---|---|
| pic_parameter_set_rbsp( ){ | C | Descriptor |

...

| | | |
|---|---|---|
| sip_type_flag | 0 | u(1) |
| if(sip_type_flag){ | | |

for (i=0; i<2; i++) {

| | | |
|---|---|---|
| sip_type_index[ i ] | 0 | u(1) |

}

}
...

}

The syntax in the picture parameter set is as follows:

sip_type_flag equal to 1 specifies that adaptive mode mapping is present in the picture parameter set. sip_type_flag equal to 0 specifies that adaptive mode mapping is not present in picture parameter set. The default mapping is used.

sip_type_index[i] specifies the value of the new mode index where i is the index for the default mapping.

It is reasonable to expect that the sip_type distributions are different for low and high resolution videos. For example, INTRA4×4 will be selected more often for low resolution videos, and INTRA8×8 will be selected more often for high resolution videos. TABLE 4 and TABLE 5 illustrate how to adapt the mode mapping based on the picture resolution for low and high resolution videos, respectively. In particular, TABLE 4 shows the specification of sip_type for sip_type_flag=0, and TABLE 5 shows the specification for sip_type for sip_type_flag=1. In low resolution videos, INTRA4×4 is indexed as 0 and INTRA8×8 as 1. sip_type=0 (INTRA4×4) is coded with a short codeword as it will likely be selected more often. This mapping is also used as the default mapping. In high resolution videos, INTRA8×8 is indexed as 0 and INTRA4×4 as 1. This is to guarantee that the more probable mode is indexed as 0 and coded with a short codeword. TABLE 6 is used to represent the change in the mode index, where i is the default mode index and sip_type_index[i] is the new mode index. In particular, TABLE 6 shows an example of mode mapping when sip_type_flag=1.

TABLE 4

| | | Partition type for |
|---|---|---|
| sip_type | Code | the Intra block |
| 0 | 0 | 4 × 4 partitions |
| 1 | 010 | 8 × 8 partitions |

TABLE 5

| | | Partition type for |
|---|---|---|
| sip_type | Code | the Intra block |
| 0 | 0 | 8 × 8 partitions |
| 1 | 010 | 4 × 4 partitions |

TABLE 6

| i | sip_type_index[i] |
|---|---|
| 0 | 1 |
| 1 | 0 |

A description will now be given of some of the many attendant advantages/features of the present invention, some of which have been mentioned above. For example, one advantage/feature is an apparatus having an encoder for encoding adapted mode mapping information for a mapping between values of a mode index and modes available to encode at least a portion of a picture in a sequence of pictures. The adapted mode mapping information is adapted based on one or more actual parameters of the sequence.

Another advantage/feature is the apparatus having the encoder as described above, wherein the picture is a currently coded picture, and the actual parameters include coding information for one or more previously coded pictures in the sequence.

Yet another advantage/feature is the apparatus having the encoder wherein the picture is a currently coded picture, and the actual parameters include coding information for one or more previously coded pictures in the sequence as described above, wherein the coding information comprises at least one of a frequency of mode usage, at least one spatial resolution, and at least one temporal resolution.

Still another advantage/feature is the apparatus having the encoder as described above, wherein at least a portion of the sequence is encoded into a resultant bitstream, and the adapted mode mapping information is signaled in the resultant bitstream.

Moreover, another advantage/feature is the apparatus having the encoder as described above, wherein the adapted mode mapping information is signaled using at least one high level syntax element.

Further, another advantage/feature is the apparatus having the encoder wherein the adapted mode mapping information is signaled using at least one high level syntax element as described above, wherein the high level syntax element is included in at least one of a slice header, a sequence parameter set, a picture parameter set, a network abstraction layer unit header, and a supplemental enhancement information message.

Also, another advantage/feature is the apparatus having the encoder as described above, wherein the adapted mode mapping information is updated after encoding one or more pictures of the sequence.

Additionally, another advantage/feature is the apparatus having the encoder as described above, wherein the actual parameters are determined from at least one of coding information for one or more previously coded pictures in the sequence, a selected subset of a set of adapted mode mapping information relating to at least a portion of the sequence, one or more partial encoding passes for the picture, statistics of one or more pictures in the sequence, statistics of one or more portions of the one or more pictures in the sequence, and statistics of the sequence.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding mode mapping information for a mapping between values of a mode index and modes available to encode at least a portion of a picture in a sequence of pictures, wherein the mode mapping information is adapted responsive to one or more actual parameters of the sequence.

2. The apparatus of claim 1, wherein the picture is a currently coded picture, and the actual parameters comprise coding information for one or more previously coded pictures in the sequence.

3. The apparatus of claim 2, wherein the coding information comprises at least one of a frequency of mode usage, at least one spatial resolution, and at least one temporal resolution.

4. The apparatus of claim 1, wherein at least a portion of the sequence is encoded into a resultant bitstream, and the adapted mode mapping information is signaled in the resultant bitstream.

5. The apparatus of claim 1, wherein the adapted mode mapping information is signaled using at least one high level syntax element.

6. The apparatus of claim 5, wherein the high level syntax element is comprised in at least one of a slice header, a sequence parameter set, a picture parameter set, a network abstraction layer unit header, and a supplemental enhancement information message.

7. The apparatus of claim 1, wherein the adapted mode mapping information is updated after encoding one or more pictures of the sequence.

8. The apparatus of claim 1, wherein the actual parameters are determined from at least one of coding information for one or more previously coded pictures in the sequence, a selected subset of a set of adapted mode mapping information relating to at least a portion of the sequence, one or more partial encoding passes for the picture, statistics of one or more pictures in the sequence, statistics of one or more portions of the one or more pictures in the sequence, and statistics of the sequence.

9. A method, comprising:
encoding mode mapping information for a mapping between values of a mode index and modes available to encode at least a portion of a picture in a sequence of pictures, wherein the mode mapping information is adapted responsive to one or more actual parameters of the sequence.

10. The method of claim 9, wherein the picture is a currently coded picture, and the actual parameters comprise coding information for one or more previously coded pictures in the sequence.

11. The method of claim 10, wherein the coding information comprises at least one of a frequency of mode usage, at least one spatial resolution, and at least one temporal resolution.

12. The method of claim 9, wherein at least a portion of the sequence is encoded into a resultant bitstream, and the adapted mode mapping information is signaled in the resultant bitstream.

13. The method of claim 9, wherein the adapted mode mapping information is signaled using at least one high level syntax element.

14. The method of claim 13, wherein the high level syntax element is comprised in at least one of a slice header, a sequence parameter set, a picture parameter set, a network abstraction layer unit header, and a supplemental enhancement information message.

15. The method of claim 9, wherein the adapted mode mapping information is updated after encoding one or more pictures of the sequence.

16. The method of claim 9, wherein the picture is a currently coded picture, and the actual parameters are determined from at least one of coding information for one or more previously coded pictures in the sequence, a selected subset of a set of adapted mode mapping information relating to at least a portion of the sequence, one or more partial encoding passes for the picture, statistics of one or more pictures in the sequence, statistics of one or more portions of the one or more pictures in the sequence, and statistics of the sequence.

17. An apparatus, comprising:
a decoder for decoding mode mapping information for a mapping between values of a mode index and modes available to decode at least a portion of a picture in a sequence of pictures, wherein the mode mapping information is adapted responsive to one or more actual parameters of the sequence.

18. The apparatus of claim 17, wherein the picture is a currently coded picture, and the actual parameters comprise coding information for one or more previously coded pictures in the sequence.

19. The apparatus of claim 18, wherein the coding information comprises at least one of a frequency of mode usage, at least one spatial resolution, and at least one temporal resolution.

20. The apparatus of claim 17, wherein at least a portion of the sequence is decoded from a resultant bitstream, and the adapted mode mapping information is determined from the resultant bitstream.

21. The apparatus of claim 17, wherein the adapted mode mapping information is signaled using at least one high level syntax element.

22. The apparatus of claim 21, wherein the high level syntax element is comprised in at least one of a slice header, a sequence parameter set, a picture parameter set, a network abstraction layer unit header, and a supplemental enhancement information message.

23. The apparatus of claim 17, wherein the adapted mode mapping information is updated after decoding one or more pictures of the sequence.

24. The apparatus of claim 17, wherein the actual parameters are determined from at least one of coding information for one or more previously coded pictures in the sequence, a selected subset of a set of adapted mode mapping information relating to at least a portion of the sequence, statistics of one or more pictures in the sequence, statistics of one or more portions of the one or more pictures in the sequence, and statistics of the sequence.

25. A method, comprising:
decoding mode mapping information for a mapping between values of a mode index and modes available to decode at least a portion of a picture in a sequence of pictures, wherein the mode mapping information is adapted responsive to one or more actual parameters of the sequence.

26. The method of claim 25, wherein the picture is a currently coded picture, and the actual parameters comprise coding information for one or more previously coded pictures in the sequence.

27. The method of claim 26, wherein the coding information comprises at least one of a frequency of mode usage, at least one spatial resolution, and at least one temporal resolution.

28. The method of claim 25, wherein at least a portion of the sequence is decoded from a resultant bitstream, and the adapted mode mapping information is determined from the resultant bitstream.

29. The method of claim 25, wherein the adapted mode mapping information is signaled using at least one high level syntax element.

30. The method of claim 29, wherein the high level syntax element is comprised in at least one of a slice header, a sequence parameter set, a picture parameter set, a network abstraction layer unit header, and a supplemental enhancement information message.

31. The method of claim 25, wherein the adapted mode mapping information is updated after decoding one or more pictures of the sequence.

32. The method of claim 25, wherein the actual parameters are determined from at least one of coding information for one or more previously coded pictures in the sequence, a selected subset of a set of adapted mode mapping information relating to at least a portion of the sequence, statistics of one or more pictures in the sequence, statistics of one or more portions of the one or more pictures in the sequence, and statistics of the sequence.

33. A computer-readable storage media having video signal data encoded thereupon, comprising:
mode mapping information for a mapping between values of a mode index and modes available to encode at least a portion of a picture in a sequence of pictures, wherein the mode mapping information is adapted responsive to one or more actual parameters of the sequence
